(19) United States
(12) Patent Application Publication
(10) Pub. No.: US 2015/0270574 A1
(43) Pub. Date: Sep. 24, 2015

(54) HALOGENOSILANE FUNCTIONALIZED CARBONATE ELECTROLYTE MATERIAL, PREPARATION METHOD THEREOF AND USE IN ELECTROLYTE FOR LITHIUM ION BATTERY

(71) Applicants: Hao LUO, (US); Jinglun WANG, (US); Lingzhi ZHANG, (US); GUANGZHOU INSTITUTE OF ENERGY CONVERSION, CHINESE ACADEMY OF SCIENCES), Guangzhou, Guangdong (CN)

(72) Inventors: Lingzhi Zhang, Tianhe Guangzhou (CN); Jinglun Wang, Tianhe Guangzhou (CN); Hao Luo, Tianhe Guangzhou (CN)

(21) Appl. No.: 14/430,480

(22) PCT Filed: Nov. 7, 2012
(86) PCT No.: PCT/CN2012/084205

§ 371 Date: Mar. 23, 2015

(30) Foreign Application Priority Data
Sep. 24, 2012 (CN) 201210358351.0

(51) Int. Cl. H01M 10/0567; C07F 7/18; C07F 7/12; H01M 10/0569; H01M 10/0525

(52) U.S. Cl. CPC H01M 10/0567; H01M 10/0569; H01M 10/0525; C07F 7/122; C07F 7/1876; H01M 2300/0034

(57) ABSTRACT

A class of halogensilane-functionalized carbonate electrolyte materials, a preparation method thereof and use in a lithium ion battery. The chemical structure is shown in formula 1, the compound containing a halogenosilane group and an organic carbonate group wherein the organic carbonate moiety contained in the molecular structure facilitates the dissociation and conduction of the lithium ions, and the organic silicon functional group can improve surface performance of the electrode and enhance interface performance of the material. The halogenosilane functionalized carbonate electrolyte materials can be used as a functional additive or a cosolvent for a lithium ion battery, and the electrolyte includes a lithium salt, a solvent with a high dielectric constant or an organic solvent with a low boiling point, and a compound with the chemical structure of formula 1. Such materials can also be used in other electrochemical energy storage devices.

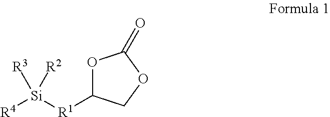

### TECHNICAL FIELD

The present invention relates to chemical material synthesis and electrochemical energy storage technology, and particularly to a class of halogenosilane functionalized carbonate electrolyte material, preparation method and thereof use as functional electrolyte additive (or cosolvent) for lithium ion battery.

### BACKGROUND

Lithium ion battery has characteristics of high open circuit voltage, high specific capacity, long cycle life, good safety performance, low self-discharge, wide application scope, no memory effect, no pollution and etc. It has been widely used in consumer electronic products and evolves to fields such as national defense industry, space technology, electric vehicle and static type backup power supply.

Electrolyte is an important part of lithium ion battery, which acts like a bridge to connect anode and cathode through lithium ion conduction. The basic physiochemical properties and interfacial properties with anode and cathode electrode greatly affect the performance of battery. To choose proper electrolyte is one of key factors for lithium ion batteries to achieve high energy density and power density, long cycle life and good safety. Current commercial electrolyte is mainly comprised of organic carbonate solvents, which is flammable and volatile, resulting in potential safety hazard in technology. In addition, organic carbonate electrolyte has defects of short of high and low temperature performance, safety, large capacity and high C-rate performance. When adding small amount of functional electrolyte additives, the electrochemical properties of the battery, such as electric conductivity, cycle efficiency and reversible capacity, can be improved significantly. They have characteristics of “small dose, fast effect”, which is operated simply and can be directly added to organic electrolyte. Functional electrolyte additive has the merit of “small dose, high effective”, which is considered as one of the economic route to dramatic improve the performance of lithium ion batteries.

Organosilicon electrolyte material has advantages of excellent thermal stability, low temperature ionic conductive performance, high conductivity, nontoxicity, low flammability and high decomposition voltage and so on. It has higher electrochemical stability (4.5V above) compared with carbon based analogues. The lithium ion battery with liquid organosilicon electrolyte exhibits excellent charge/discharge performance, cycling performance, high energy density, and high power density. Effects of substituted group on organosilicon compounds are also studied through computation method, in which the electrochemical window of organosilicon compound can be promoted by electron withdrawing groups substitution (J. Phys. Chem. C. 2011, 115, 12216). Halogenosilane compound is seldom used in lithium ion battery. Previous patents illustrate influence of fluoroalkyl silane, which is synthesized by reaction of organosilicon compound and fluorine containing alkali metal salt, on battery impedance performance (CN102113164), and mention potential possibility of organic fluoroalkyl silane being used as additives in lithium ion battery (US2009/0197167A1). Although there is a few research of halogenosilane compound being used as electrolyte material or additive of lithium battery, it is of great significance to design new halogenosilane compound used in lithium ion battery.

### SUMMARY

An object of the present invention is to provide a class of widely used halogenosilane functionalized carbonate electrolyte material containing halogenosilane group and organic carbonate group, preparation method thereof and use as electrolyte functional additive or cosolvent in lithium ion battery.

The halogenosilane functionalized carbonate electrolyte material of the present invention has chemical structure as shown in formula 1:

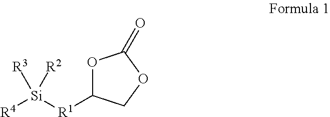

Wherein R¹ is selected from following structure: methylene [—(CH₂)ₘ—, m=1˜3] or containing ether chain [—(CH₂)ₘO(CH₂)ₙ—, m, n=1˜3] group; R², R³, R⁴ are selected from alkyl[-(CH₂)ₘCH₃, m=0˜3], aryl (or substituted aryl), or X (halogen) substitution; and R², R³, R⁴ have at least one X substituted group, halogen is preferably —Cl, —F. Compound of formula 1 contains halogenosilane group and organic carbonate group, organosilicon group being halogenosilane group, the organic carbonate group being 4-[(oxypropyl)methyl]-1,3-dioxolane-2-ketone or 4-ethyl-1,3-dioxolane-2-ketone. Wherein the halogenosilane group may be single halogenated, dihalogeno or trihalogeno silane compound, and may be chlorosilane group or fluoroalkyl silane group. Organic carbonate in molecular structure contributes to dissociation and conduction of lithium ion, and organic silicon functional group can improve surface performance of the electrode and promote interface performance of the material.

The present invention further provides a method for preparting halogenosilane functionalized carbonate electrolyte material. The method comprises following steps: (1) hydrosilylation of double bonds substituted carbonate with halogenated hydrosilane or alkoxy hydrosilane, prepare corresponding halogenosilane or alkoxy silane substituted carbonate; (2) product of step (1) reacts with fluorinating agent to form fluoroalkyl silane substituted carbonate.

The double bonds substituted carbonate is 4-[(allyloxy)methyl]-1,3-dioxolane-2-ketone or 4-vinyl-1,3-dioxolane-2-ketone; the halogenated hydrosilane is chlorinated hydrosilane; the alkoxy hydrosilane is methoxy substituted hydrosilane or ethoxy substituted hydrosilane; and molar ratio of double bonds substituted carbonate and hydrosilane is 1:1.0˜1.5.

Catalyst of the hydrosilylation is selected from chloroplatinic acid, platinum dioxide or Karstedt's catalyst, with the dose of 0.1˜1 mol % (molar ratio to double bonds carbonate); the fluorinating agent includes boron trifluoride ether, antimony trifluoride, potassium fluoride or lithium fluoride, and molar ratio of the fluorinating agent and halogenosilane or alkoxylsilane substituted carbonate is 3˜1:1.

Reaction is carried out under an inert gas protection environment; temperature of the hydrosilylation is 30˜80° C., and reaction time is 2˜24 hours; temperature of fluoridation is 30˜80° C., and reaction time is 2˜24 hours.

The present invention further provides the use of halogenosilane functionalized carbonate electrolyte material of formula 1 in lithium ion battery. The halogenosilane functionalized carbonate electrolyte material may be used as functional electrolyte additive or cosolvent in lithium ion battery. The lithium ion battery electrolyte comprises the organic compound of formula 1, and lithium salt, high dielectric constant solvent or organic solvent with low boiling point.

The organosilicon functionalized carbonate electrolyte material may as well be used as electrolyte material in other electrochemical energy storage devices (for example fuel cells, electrolytic capacitor and supercapacitor) and other photoelectric devices (such as organic solar cells).

### BRIEF DESCRIPTION OF THE DRAWINGS

FIG. 1 shows 1H NMR spectrum and ¹³C NMR spectrum of compound according to embodiment 1 of the present invention.

FIG. 2 shows 1H NMR spectrum and ¹³C NMR spectrum of compound according to embodiment 2 of the present invention.

FIG. 3 shows 1H NMR spectrum and ¹³C NMR spectrum of compound according to embodiment 3 of the present invention.

FIG. 4 shows 1H NMR spectrum and ¹³C NMR spectrum of compound according to embodiment 4 of the present invention.

FIG. 5 shows 1H NMR spectrum and ¹³C NMR spectrum of compound according to embodiment 5 of the present invention.

FIG. 6 shows 1H NMR spectrum and ¹³C NMR spectrum of compound according to embodiment 6 of the present invention.

FIG. 7 shows electrochemical window of compound (MFGC) of embodiment 4 of the present invention.

FIG. 8 shows ionic conductivity of compound (MFGC) of embodiment 4 of the present invention.

FIG. 9 shows battery performance test of compound (MFGC) of embodiment 4 of the present invention being added in commercial electrolyte (1M LiPF₆ EC/DMC/DEC=1:1:1).

### DETAILED DESCRIPTION

The invention will be further described with accompanied drawings and embodiments.

Two preparation routes of halogenosilane functionalized carbonate electrolyte material of the present invention are shown:

Method 1: (1) hydrosilylation of 4-[(allyloxy)methyl]-1,3-dioxolane-2-ketone or 4-vinyl-1,3-dioxolane-2-ketone with alkoxy hydrosilane to prepare alkoxy silane substituted 4-[(oxypropyl)methyl]-1,3-dioxolane-2-ketone or alkoxy silane substituted 4-ethyl-1,3-dioxolane-2-ketone; (2) alkoxy silane substituted 4-[(oxypropyl)methyl]-1,3-dioxolane-2-ketone or alkoxy silane substituted 4-ethyl-1,3-dioxolane-2-ketone reacts with fluorinating agent (including boron trifluoride•ether, antimony trifluoride, alkali metal salt containing fluorine) to prepare corresponding fluoroalkyl silane functionalized carbonate electrolyte material. The detailed synthetic route is shown below.

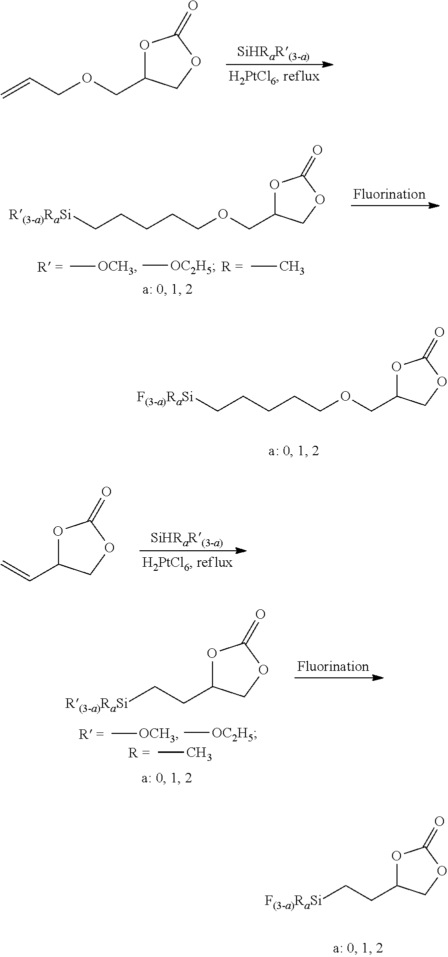

The procedures of the above reaction are detailed as below: (1) alkoxy silane substituted 4-[(oxypropyl)methyl]-1,3-dioxolane-2-ketone or alkoxy silane substituted 4-ethyl-1,3-dioxolane-2-ketone is prepared: At room temperature, alkoxy hydrosilane (1.1 eq.) is dropped into the 4-[(allyloxy)methyl]-1,3-dioxolane-2-ketone or 4-vinyl-1,3-dioxolane-2-ketone with 0.1˜1 mol % platinum catalyst, and after then, the reaction temperature rises to 85° C., reaction lasts 12 hours, after completion of the reaction, alkoxy silane substituted 4-[(oxypropyl)methyl]-1,3-dioxolane-2-ketone or alkoxy silane substituted 4-ethyl-1,3-dioxolane-2-ketone was obtained through distillation. (2) halogenosilane functionalized carbonate electrolyte material is prepared: Under protection of argon, boron trifluoride ether solvent (molar ratio of boron trifluoride ether to alkoxy silane substituted carbonate is 3˜1:1) is dropped into, alkoxy silane substituted 4-[(oxypropyl)methyl]-1,3-dioxolane-2-ketone or alkoxy silane substituted 4-ethyl-1,3-dioxolane-2-ketone in toluene, the mixture was heated overnight, after completion of the reaction, the solvent was evaporated and the target product was purified under reduced pressure.

Method 2: (1) hydrosilylation of 4-[(allyloxy)methyl]-1,3-dioxolane-2-ketone or 4-vinyl-1,3-dioxolane-2-ketone and chlorinated hydrosilane to prepare chlorinated silane substituted 4-[(oxypropyl)methyl]-1,3-dioxolane-2-ketone or chlorine silane substituted 4-ethyl-1,3-dioxolane-2-ketone. (2) chlorinated silane substituted 4-[(oxypropyl)methyl]-1,3-dioxolane-2-ketone or chlorine silane substituted 4-ethyl-1,3-dioxolane-2-ketone, and fluorinating agent (including boron trifluoride ether, antimony trifluoride, alkali metal salt containing fluorine) react to prepare corresponding fluoroalkyl silane functionalized carbonate electrolyte material. The detailed synthetic route is shown as below.

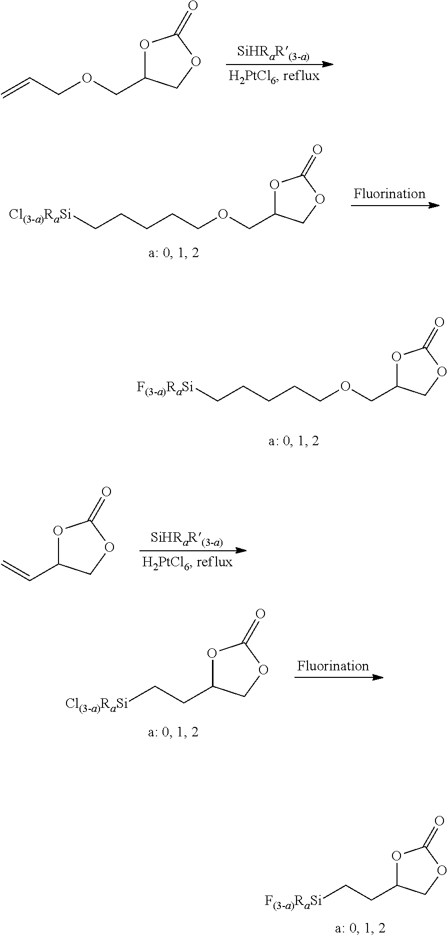

The detailed steps of the above method 2 reaction are as below: (1) chlorinated silane substituted 4-[(oxypropyl)methyl]-1,3-dioxolane-2-ketone or chlorinated silane substituted 4-ethyl-1,3-dioxolane-2-ketone is prepared: At room temperature, chlorinated hydrosilane (1.1 eq.) is slowly dropped into the 4-[(allyloxy)methyl]-1,3-dioxolane-2-ketone or 4-vinyl-1,3-dioxolane-2-ketone with 0.1˜1 mol % platinum catalyst, and after dropping, when temperature of reaction system rises to 85° C., reaction lasts 12 hours, to form hydrosilation product. (2) fluoroalkyl silane functionalized carbonate electrolyte material is prepared: Under protection of argon, potassium fluoride (molar ratio of potassium fluoride and chlorinated silane substituted carbonate is 3˜1:1) is dropped into a acetonitrile solution containing chlorinated silane substituted 4-[(oxypropyl)methyl]-1,3-dioxolane-2-ketone or chlorinated silane substituted 4-ethyl-1,3-dioxolane-2-ketone, stiring at room temperature, reacting overnight, after completion of the reaction, the solvent is evaporated and the target product is purified under reduced pressure.

Chemical structures of the compounds of embodiments 1-6 are shown below:

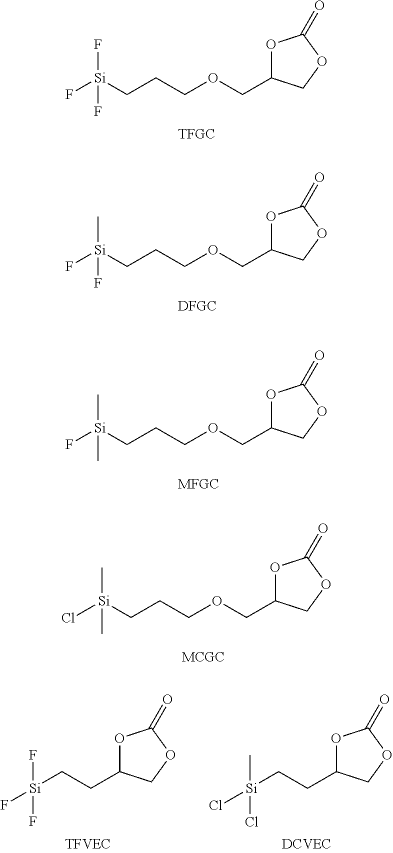

### Embodiment 1

### Synthesis of trifluoro silane substituted 4-[(oxypropyl)methyl]-1,3-dioxolane-2-ketone (TFGC)

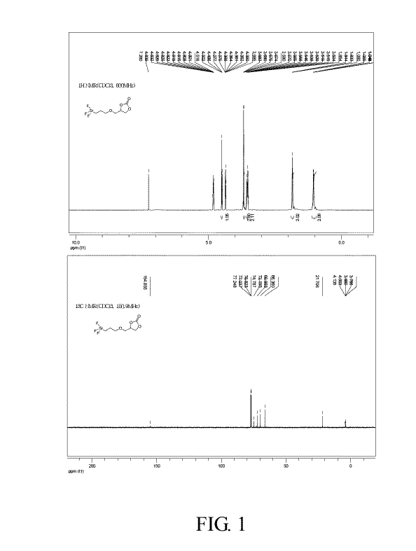

Under protection of argon, 4-[(allyloxy)methyl]-1,3-dioxolane-2-ketone (0.1 mol) reacted with triethoxy silane (0.11 mol) using chloroplatinic acid (0.4% mol) as catalyst, the reaction temperature rose to 85° C., reaction lasts 12 hours, after completion of the reaction, triethoxy silane substituted allyl glycerol carbonate compound was obtained through distillation. Boron trifluoride•ether (0.1 mol) was dropped into triethoxy silane substituted allyl glycerol carbonate (0.05 mol) toluene solvent, and was heated to 80° C. for hours, after completion of the reaction, solvent was evaporated, trifluoro silane substituted allyl glycerol carbonate was purified under reduced pressure, which was NMR characterized to form NMR spectrum as FIG. 1:

¹H NMR (600 MHz, CDCl₃): δ=1.05 (m, 2H, SiCH₂CH₂), 1.84 (m, 2H, SiCH₂CH₂), 3.54 (m, 2H, SiCH₂CH₂CH₂), 3.68 (m, 2H, OCH₂CH), 4.36 (m, 1H, CH₂), 4.50 (m, 1H, CH₂), 4.84 (m, 1H, CH).

¹³C NMR (150.9 MHz, CDCl₃): 3.77, 3.88, 4.00, 4.14, 21.71, 66.36, 69.99, 72.20, 74.79, 154.86.

### Embodiment 2

### Synthesis of trifluoro silane substituted 4-ethyl-1,3-dioxolane-2-ketone (TFVEC)

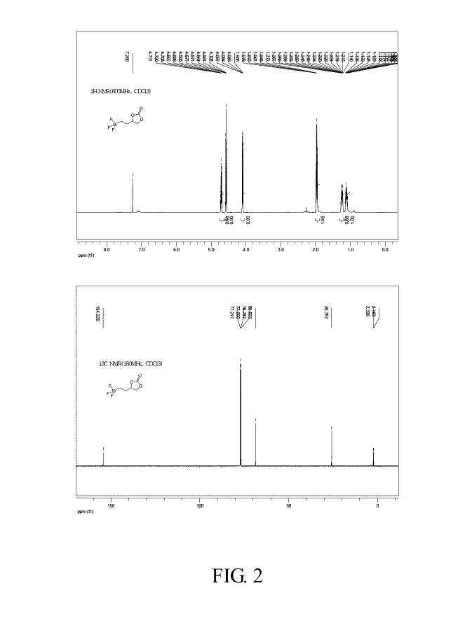

4-vinyl-1,3-dioxolane-2-ketone was used to react with the same synthesis method as the embodiment 1, after completion of the reaction, the target product was purified under reduced pressure, which was NMR characterized to form NMR spectrum as FIG. 2:

¹H NMR (600 MHz, CDCl₃): δ=1.10 (m, 1H, SiCH₂CH₂), 1.25 (m 1H, SiCH₂CH₂), 1.97 (m, 2H, SiCH₂CH₂), 4.09 (t, ³J=8.4 Hz, 1H, CH₂), 4.57 (m, 1H, ³J=8.4 Hz, CH₂), 4.71 (m, 1H, CH).

¹³C NMR (150.9 MHz, CDCl₃): 2.20, 25.76, 68.62, 76.79, 154.32.

### Embodiment 3

### Synthesis of monomethyl difluoro silane substituted 4-[(oxypropyl)methyl]-1,3-dioxolane-2-ketone (DFGC)

Diethoxy silane was used to react with the same synthesis method as the embodiment 1, after completion of the reaction, the target product was purified under reduced pressure.

The method 2 described in the patent can also be used: 4-[(allyloxy)methyl]-1,3-dioxolane-2-ketone (0.2 mol) reacted with monomethyl dichloro hydrosilane (0.2 mol) using chloroplatinic acid (0.4% mol) as catalyst, to prepare monomethyl dichloro hydrosilane substituted 4-[(propoxy)methyl]-1,3-dioxolane-2-ketone; monomethyl dichloro hydrosilane substituted 4-[(propoxy)methyl]-1,3-dioxolane-2-ketone and potassium fluoride reacted in acetonitrile solvent to prepare corresponding monomethyl difluoro silane substituted 4-[(propoxy)methyl]-1,3-dioxolane-2-ketone.

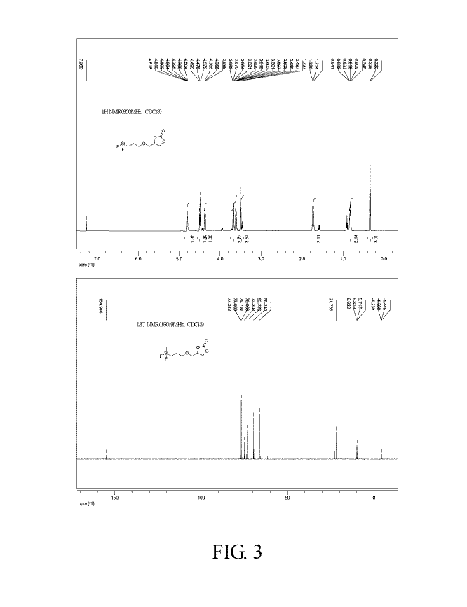

It is NMR characterized to form NMR spectrum as FIG. 3:

¹H NMR (600 MHz, CDCl₃): δ=0.34 (t, 3H, ³J=6.0 Hz, SiCH₃), 0.82 (m, 2H, SiCH₂CH₂), 1.73 (m, 2H, SiCH₂CH₂), 3.50 (t, 2H, ³J=6.0 Hz, SiCH₂CH₂CH₂), 3.60 (dq, 2H, ³J=10.8 Hz, OCH₂CH), 4.37 (dd, 1H, ³J=10.8 Hz, CH₂), 4.49 (dd, 1H, ³J=10.8 Hz, CH₂), 4.80 (m, 1H, CH).

¹³C NMR (150.9 MHz, CDCl₃): −4.34 (t, ³J=16.05), 9.82 (t, ³J=15.45), 21.74, 66.21, 69.78, 73.20, 75.01, 154.95.

### Embodiment 4

### Synthesis of dimethyl monofluoro silane substituted 4-[(oxypropyl)methyl]-1,3-dioxolane-2-ketone (MFGC)

4-[(allyloxy)methyl]-1,3-dioxolane-2-ketone (0.2 mol) reacted with dimethyl monochlorine hydrosilane (0.2 mol) using chloroplatinic acid (0.4% mol) as catalyst, to prepare dimethyl monochlorine hydrosilane substituted 4-[(propoxy)methyl]-1,3-dioxolane-2-ketone; dimethyl monochlorine silane substituted 4-[(propoxy)methyl]-1,3-dioxolane-2-ketone and potassium fluoride reacted in acetonitrile solvent to prepare corresponding dimethyl monofluoro silane substituted 4-[(propoxy)methyl]-1,3-dioxolane-2-ketone.

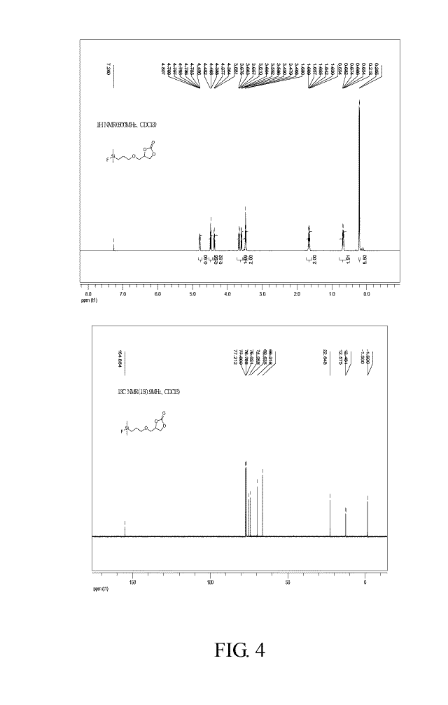

The method 1 described in the patent can also be used: monoethoxy methyl silane was used to react with the same synthesis method as the embodiment 1, after completion of the reaction, the target product was purified under reduced pressure, which was NMR characterized to form NMR spectrum as FIG. 4:

¹H NMR (600 MHz, CDCl₃): δ=0.10 (s, 3H, SiCH₃), 0.59 (t, 2H, SiCH₂CH₂), 1.19 (t, 6H, Si(OCH₂H₃)₂), 1.63 (m, 2H, SiCH₂CH₂), 3.46 (m, 2H, SiCH₂CH₂CH₂), 3.62 (dq, 2H, ³J=10.8 Hz, OCH₂CH), 3.74 (q, 4H, ³J=7.2 Hz, Si(OCH₂H₃)₂), 4.38 (dd, 1H, ³J=6.0 Hz, CH₂), 4.47 (dd, 1H, ³J=6.0 Hz, CH₂), 4.78 (m, 1H, CH). ¹³C NMR (150.9 MHz, CDCl₃): −5.0, 9.7, 18.3, 22.9, 58.1, 66.2, 69.5, 74.3, 75.0, 154.9.

### Embodiment 5

### Synthesis of dimethyl monochloro silane substituted 4-[(oxypropyl)methyl]-1,3-dioxolane-2-ketone (MCGC)

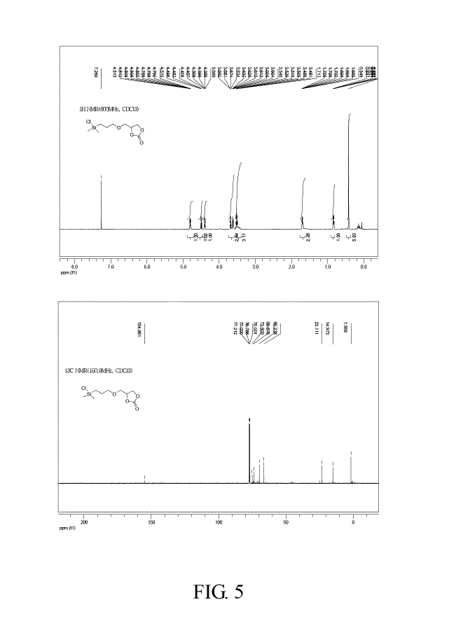

4-[(allyloxy)methyl]-1,3-dioxolane-2-ketone (0.2 mol) reacted with dimethyl monochloro hydrosilane (0.2 mol) using chloroplatinic acid (0.4% mol) as catalyst, to prepare monomethyl dichloro silane substituted 4-[(propoxy)methyl]-1,3-dioxolane-2-ketone, after completion of the reaction, the target product was purified under reduced pressure, which was NMR characterized to form NMR spectrum as FIG. 5:

¹H NMR (600 MHz, CDCl₃): δ=0.42 (s, 6H, Si(CH₃)₂), 0.83 (m, 2H, SiCH₂CH₂), 1.70 (m, 2H, SiCH₂CH₂), 3.52 (m, 2H, SiCH₂CH₂CH₂), 3.65 (dq, 2H, ³J=10.8 Hz, OCH₂CH), 4.40 (t, 1H, ³J=8.4 Hz, CH₂), 4.50 (t, 1H, ³J=8.4 Hz, CH₂), 4.80 (m, 1H, CH).

¹³C NMR (150.9 MHz, CDCl₃): 1.57, 14.97, 23.11, 66.24, 69.68, 73.90, 75.00, 154.86.

### Embodiment 6

### Synthesis of monomethyl dichloro silane substituted 4-vinyl-1,3-dioxolane-2-ketone (DCVEC)

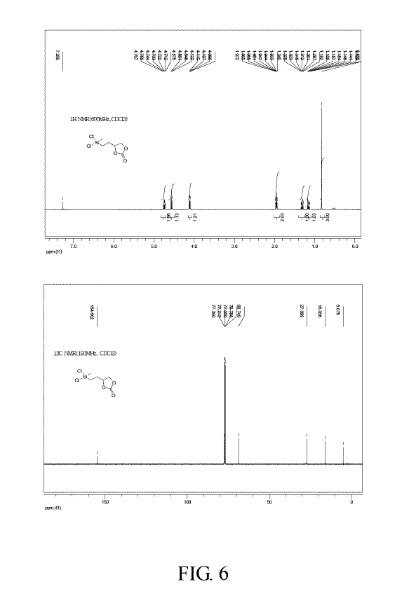

4-vinyl-1,3-dioxolane-2-ketone (0.2 mol) reacted with monomethyl dichloro hydrosilane (0.2 mol) using chloroplatinic acid (0.4% mol) as catalyst, to prepare monomethyl dichloro silane substituted 4-vinyl-1,3-dioxolane-2-ketone, after completion of the reaction, the target product was purified under reduced pressure, which was NMR characterized to form NMR spectrum as FIG. 6:

¹H NMR (600 MHz, CDCl₃): δ=0.83 (s, 3H, SiCH₃), 1.23 (m, 2H, SiCH₂CH₂), 1.95 (m, 2H, SiCH₂CH₂), 4.10 (t, ³J=8.4 Hz, 1H, CH₂), 4.56 (m, 1H, ³J=8.4 Hz, CH₂), 4.73 (m, 1H, CH).

¹³C NMR (150.9 MHz, CDCl₃): 5.08, 16.04, 27.10, 68.74, 76.79, 154.60.

### Embodiment 7

### Battery Fabrication and Test

Compound of the invention is used in lithium ion battery, and is fabricated with following procedures.

High dielectric constant solvent is not restricted particularly, and is generally normal solvent in battery field, for example, cyclic carbonate such as ethylene carbonate, propylene carbonate or γ-butyrolactone and so on. Organic solvent with low boiling point is not restricted particularly, and may be diethyl carbonate, dimethyl carbonate, methyl ethyl carbonate dimethyl oxide ethane, or fatty acid ester derivatives. Volume ratio of high dielectric constant solvent and low boiling point solvent may be 1:1 to 1:9, and high dielectric constant solvent and low boiling point solvent may be used alone. Lithium salt may be normally used lithium salt in lithium battery. For example, lithium salt may be selected from at least one of LiClO₄, LiCF₃SO₃, LiPF₆, LiN(CF₃SO₂)₂, Li(BC₄O₈), LiN(C₂F₅SO₂)₂ and etc. Concentration of lithium salt in organic electrolyte may be 0.5-2.0 M.

Cathode active material, conductive agent, binder and solvent are blended to prepare anode active material compound. The cathode active material compound is directly coated on aluminum current collector and is dried to prepare cathode plate. The cathode active material compound flows along a single substrate, and film thereof is laminated on the aluminum current collector to prepare cathode plate.

Cathode active material may be normally used metal oxide containing lithium in the field. The metal oxide containing lithium comprises, for example, LiCoO₂, LiMnₓO₂ₓ (wherein x=1, 2), LiNi₁₋ₓMnₓO₂ (wherein 0<x<1) and LiNi_{1-x-y}CoₓMn_{y}O₂ (wherein 0≦x≦0.5, 0≦y≦0.5) and LiFePO₄.

Carbon black may be used as conductive agent. Adhesive agent may be selected from vinylidene fluoride/hexafluoropropylene copolymer, polyvinylidenefluoride (PVDF), polyacrylonitrile, polymethylmethacrylate, polytetrafluoroethylene and mixture thereof, or styrene butadiene rubber based polymer. The solvent may be selected from N-methylpyrrolidone (NMP), acetone and water and etc. Dose of the anode active material, conductive agent, adhesive agent and solvent may be normal dose as used in lithium battery of prior art.

Silicon, silicon film, lithium metal, lithium alloy, carbon material or graphite may be used as anode active material. Conductive agent, adhesive agent and solvent may be the same as used in cathode active material compound. If needed, plasticizer may be added to the anode active material compound and the cathode active material compound for forming holes in electrode plate.

Membrane may consist of any material normally used in lithium battery. Material, which has low impedance to movement of ion in the electrolyte and has good capability of absorbing electrolyte, is used. For example, the material may be selected from glass fiber, polyester, Teflon, polyethylene, polypropylene, polytetrafluoroethylene (PTFE), and nonwoven fabrics or textile fabrics with mixture thereof. More particularly, membrane of the lithium ion battery may be selected with rollable membrane of polyethylene, polypropylene, and the lithium ion battery may be fabricated with membrane having good capability of soaking organic electrolyte.

In the experiments, electrolyte and LiPF₆ was purchased from Dongguan Shanshan Inc., lithium was purchased from China Lithium Energy, and membrane was purchased from Asashi Chemical Industry. Preparation of electrolyte and assembly of battery were both carried out under Argon (purity was larger than 99.9999%).

LiPF₆ was dissolved in ethylene carbonate, dimethyl carbonate and diethyl carbonate (EC:DMC:DEC=1:1:1) to form electrolyte with concentrate 1M, and 2 vol. % MFGC was added to the electrolyte. LiCoO₂ and Li respectively served as cathode and anode, and a coin battery (2025) was assembled and performs charge discharge test in Shenzhen Xinwei charge discharge test system, in which charge discharge voltage is 3.0 V-4.3 V.

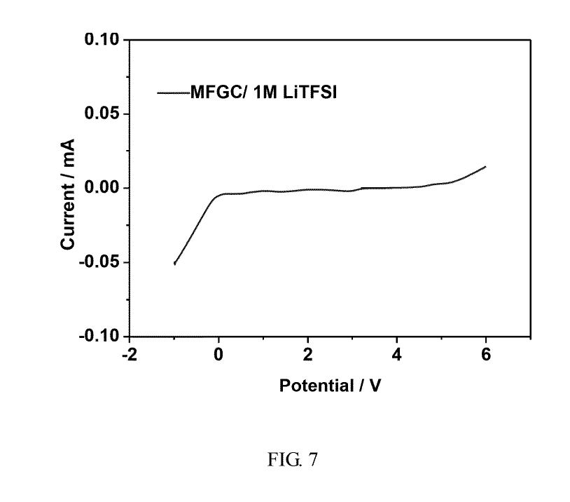

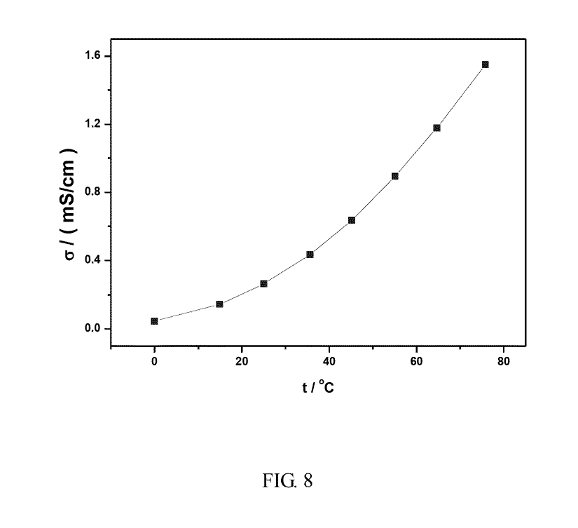

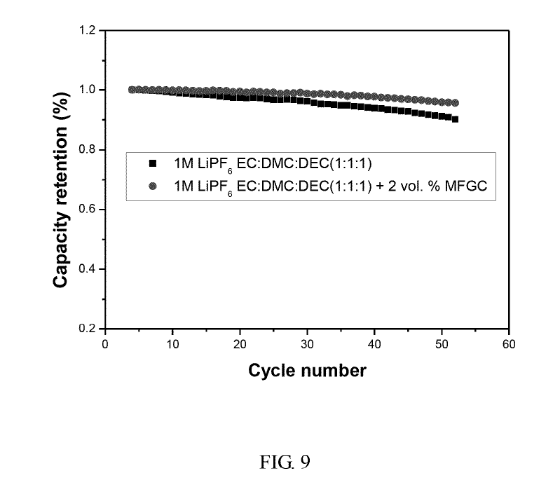

FIG. 7 shows electrochemical window of compound (MFGC) of embodiment 4 of the present invention, in which oxidation potential is higher than 5V. FIG. 8 shows ionic conductivity of compound (MFGC) of embodiment 4 of the present invention, in which 1M LiTFSI is dissolved. Table 1 shows viscosity and dielectric constant of compounds of the present invention. It can be seen that the class of compounds show relatively high dielectric constant. FIG. 9 shows cyclic performance curve of compound of embodiment 4 being added in the battery. The battery added with organic silicon functionalized carbonate has higher capacity retention rate.

TABLE 1

| | Viscosity | Dielectric |
|---|---|---|
| | (cP) | constant |
| MFGC | 16.6 | 49.2 |
| DFGC | 20.0 | 53.5 |
| TFGC | 22.7 | — |

Comparing example 1:

For comparison, commercial electrolyte (1M LiPF₆ EC:DMC:DEC=1:1:1) was used to assemble a coin battery (2025) according to the same method as the embodiment 7, and charge/discharge comparison test was performed according to the same method as the embodiment 7.

1. A halogenosilane functionalized carbonate electrolyte material, having chemical structure shown in formula 1: 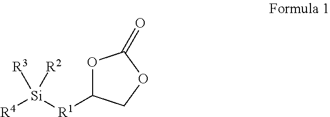
R¹ being selected from following groups: [—(CH₂)ₘ—, m=1˜3] or [—(CH₂)ₘO(CH₂)ₙ—, m, n=1˜3]; R², R³, R⁴ being selected from following groups: [—(CH₂)ₘCH₃, m=0˜3], aryl or substituted aryl, or halogen substituted group, and R², R³, R⁴ having at least one halogen substituted group.

2. A method for preparing halogenosilane functionalized carbonate electrolyte material claimed in claim 1, being characterized in comprising following steps: (1) hydrosilylation of double bonds substituted carbonate compound, and halogenated hydrosilane or alkoxy hydrosilane, preparing corresponding halogenosilane or alkoxy silane substituted carbonate; (2) product of step (1) reacting with fluorinating agent to form corresponding fluoroalkyl silane substituted carbonate.

3. The method for preparing halogenosilane functionalized carbonate electrolyte material as claimed in claim 2, being characterized in that the double bonds substituted carbonate is 4-[(allyloxy)methyl]-1,3-dioxolane-2-ketone or 4-vinyl-1,3-dioxolane-2-ketone; the halogenated hydrosilane is chlorinated hydrosilane; the alkoxy hydrosilane is methoxy substituted hydrosilane or ethoxy substituted hydrosilane; and molar ratio of double bonds substituted carbonate and hydrosilane is 1:1.0˜1.5.

4. The method for preparing halogenosilane functionalized carbonate electrolyte material as claimed in claim 2, being characterized in that catalyst of the hydrosilylation is selected from chloroplatinic acid, platinum dioxide or Karstedt's catalyst, and dose is 0.1˜1 mol % of double bonds substituted carbonate compound; the fluorinating agent comprises boron trifluoride•ether, antimony trifluoride, potassium fluoride or lithium fluoride, and molar ratio of the fluorinating agent and halogenosilane or alkoxy silane substituted carbonate is 3˜1:1.

5. The method for preparing halogenosilane functionalized carbonate electrolyte material as claimed in claim 2, being characterized in that reaction is carried out under an inert gas protection environment; temperature of the hydrosilylation is 30˜80° C., and reaction time is 2˜24 hours; temperature of fluoridation is 30˜80° C., and reaction time is 2˜24 hours.

6. Use of halogenosilane functionalized carbonate electrolyte material as claimed in claim 1 in lithium ion battery.

7. The use of halogenosilane functionalized carbonate electrolyte material in lithium ion battery as claimed in claim 6, being characterized in that the halogenosilane functionalized carbonate electrolyte material of formula 1 serves as electrolyte additive or cosolvent in electrolyte of the lithium ion battery.
